(19) United States
(12) Patent Application Publication
(10) Pub. No.: US 2026/0280941 A1
(43) Pub. Date: Sep. 17, 2026

(54) SEQUENTIAL SOUNDING SEQUENCE WITH OPTIONAL INTRA-BASIC SERVICE SET SOUNDING

(71) Applicant: Samsung Electronics Co., Ltd., Gyeonggi-do (KR)

(72) Inventors: Zigui YANG, San Jose, CA (US); Yongsen MA, Milpitas, CA (US); Aiguo YAN, San Jose, CA (US); Eunsung JEON, Gyeonggi-do (KR); Chulho CHUNG, Gyeonggi-do (KR); Mark Gorthorn RISON, Cambridge (GB)

(21) Appl. No.: 19/566,161

(22) Filed: Mar. 13, 2026

Related U.S. Application Data
(60) Provisional application No. 63/772,397, filed on Mar. 14, 2025.

(51) Int. Cl. H04L 25/02; H04B 7/024

(52) U.S. Cl. CPC H04L 25/0224; H04B 7/024

(57) ABSTRACT

A method, system, and access point are disclosed for a sequential sounding sequence with an optional intra-basic service set (BSS) sounding. The method, system, and access point determine, with a first access point (AP1) or a second access point (AP2), that an AP1 intra-BSS sounding can be adjusted from a sequential sounding sequence of a station (STA) comprising the AP1 intra-BSS sounding and an AP1 cross-BSS sounding of the STA and perform, by the AP1, with the AP2, the sequential sounding sequence of the STA based on the determination that the AP1 intra-BSS sounding can be adjusted from the sequential sounding sequence of the STA.

### CROSS-REFERENCE TO RELATED APPLICATION

This application claims the priority benefit under 35 U.S.C. § 119(e) of U.S. Provisional Application No. 63/772,397, filed on Mar. 14, 2025, the disclosure of which is incorporated by reference in its entirety as if fully set forth herein.

### TECHNICAL FIELD

The disclosure generally relates to coordinated sequential sounding. More particularly, the subject matter disclosed herein relates to improvements to sequential sounding with optional intra-basic service set (BSS) sounding.

### SUMMARY

In wireless networks, an access point (AP) can serve as a hub for a plurality of wireless network devices referred to as stations (STAs). The STAs are typically within a service area of an associated AP. The STAs may be fixed, mobile, semi-fixed, etc. The STAs may be communicatively coupled with at least the associated AP. That is, a given STA may be associated with only one AP but can communicate with non-associated APs. In addition, the STAs associated with a given AP often do not communicate directly with each other within the wireless network. However, some STAs may have additional localized wireless features, such as Bluetooth, non-AP associated wireless fidelity (Wi-Fi) networks, ad hoc mesh networks, etc. A given STA can be in a service area of two or more APs. For example, an STA may be in a first service area associated with a first AP (AP1), a second service area associated with a second AP (AP2), and/or etc.

Institute of Electrical and Electronics Engineers (IEEE) 802.11 standard is a set of physical and Media Access Control (MAC) specifications for implementing Wireless Local Area Network (WLAN) communications. The IEEE P802.11bn specification describes two sounding schemes for coordinated beamforming (Co-BF). These sounding schemes include a joint sounding scheme and a sequential sounding scheme. In sequential sounding, each STA may be sounded twice, once with intra-BSS sounding and once with cross-BSS sounding. Each STA may be any of a fixed, portable, moving, or mobile station. A plurality of STAs within the same BSS may participate in intra-BSS sounding or cross-BSS sounding at the same time or substantially contemporaneously. However, such sounding can consume overhead, such as transmission time, computing resources, etc.

To overcome these types of issues, systems and methods are described herein for a sequential sounding sequence with an optional intra-BSS sounding. The sequential sounding may be for subsequent Co-BF by an AP1 and AP2 to an STA. The sequential sounding may be defined as including the optional intra-BSS sounding of the STA and a cross-BSS sounding of the same STA. If the intra-BSS sounding is determined to be omitted or adjusted from the sequential sounding, then the sequential sounding may be performed by the AP1 and the AP2 in a coordinated manner using an indication.

In an embodiment, a method comprises determining, by an AP1, that an AP1 intra-BSS sounding can be adjusted from a sequential sounding sequence of an STA comprising the AP1 intra-BSS sounding and an AP1 cross-BSS sounding of the STA; and performing, by the AP1, with the AP2, the sequential sounding sequence of the STA based on the determination that the AP1 intra-BSS sounding may be adjusted from the sequential sounding sequence of the STA.

In an embodiment, a method comprises determining, by the AP2, that an AP1 intra-BSS sounding can be adjusted from a sequential sounding sequence of an STA comprising an AP1 intra-BSS sounding and AP1 cross-BSS sounding of the STA and performing, with the AP1, by the AP2, the sequential sounding sequence of the STA based on the determination that the AP1 intra-BSS sounding can be adjusted from the sequential sounding sequence of the STA.

In an embodiment, a system comprises the AP1 and the AP2, wherein one of the AP1 or the AP2 is configured to determine that an AP1 intra-BSS sounding can be adjusted from a sequential sounding sequence of an STA comprising the AP1 intra-BSS sounding and an AP1 cross-BSS sounding of the STA, and the AP1 and the AP2 are configured to perform the sequential sounding sequence of the STA based on the determination that the AP1 intra-BSS sounding may be adjusted from the sequential sounding sequence of the STA.

In an embodiment, an AP comprises a processing circuit configured to determine that an AP intra-BSS sounding can be adjusted from a sequential sounding sequence of an STA comprising the AP intra-BSS sounding and an AP cross-BSS sounding sequence of the STA; and a transmitter/receiver configured to transmit an indication that the AP intra-BSS sounding can be adjusted from the sequential sounding of the STA.

### BRIEF DESCRIPTION OF THE DRAWINGS

In the following section, the aspects of the subject matter disclosed herein will be described with reference to exemplary embodiments illustrated in the figures, in which:

FIG. 1 is a schematic diagram of a system 100 including an overlapping basic service set (OBSS) between AP1 and AP2 according to an embodiment;

FIG. 2 is a sequence diagram 200 of a sequential sounding sequence with an optional intra-BSS sounding according to an embodiment;

FIG. 3 is a sequence diagram 300 of a sequential sounding with an optional intra-BSS sounding according to an embodiment;

FIG. 4 shows a sequence diagram 400 of a sequential sounding sequence with an optional intra-BSS sounding according to an embodiment;

FIG. 5 is a method 500 for sequential sounding sequence including an intra-BSS sounding according to an embodiment;

FIG. 6 is a block diagram of an electronic device in a network environment 600, according to an embodiment; and

FIG. 7 shows a system 700 including an AP1 710, an AP2 720, and an STA 730.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The quality of a transmission between an AP and an STA can be encapsulated in a channel state information (CSI) report such as, for example with a channel quality indicator (CQI). A CSI report may also include information on the physical layer (PHY) measurements of the condition of a transmission channel. The CSI report can contain information related to fading, scattering, power decay, etc. of a signal propagating through the transmission channel. The CSI report may be based on statistical, instantaneous, or similar determined values. The CSI reports can be based on channel state estimation procedures that use, for example, a CSI test signal (e.g., training signal) sent over the channel. The CSI report may indicate how well an STA will receive a signal transmitted by an AP.

The CSI test signals may be used in sounding techniques. The sounding techniques may involve an AP sending the test signal to an STA and the STA subsequently responding with information on how well the STA received the test signal. For example, the test signal may comprise a training signal (e.g., short training fields, long training fields, etc.) of known sequences transmitted on orthogonal frequency division multiplexing (OFDM) subcarriers. The training signal can be transmitted by an AP during sounding of an STA. Accordingly, sounding may refer to sending a training signal over a particular transmission channel, such as between transmit and receive antennas, to generate a CSI report about the transmission channel.

At least two types of sounding may be employed: sequential sounding and joint sounding. In sequential sounding, the training signals may be sent at different times. In joint sounding, the training signals can be sent simultaneously from multiple APs to an STA. The STA can measure the training signals from the multiple APs. The STA may respond simultaneously with information about how well the training signals were heard.

The terms “intra-BSS” and “cross-BSS” can be used to distinguish transmissions between an AP and associated STAs from transmissions between the AP and non-associated STAs. For example, a test signal transmitted by an AP to an associated STA may be referred to as an intra-BSS test signal. Conversely, a test signal transmitted from an AP to a non-associated STA may be referred to as a cross-BSS test signal. Accordingly, training signals sent by an AP to associated and non-associated STAs can respectively be referred to as intra-BSS sounding and cross-BSS sounding.

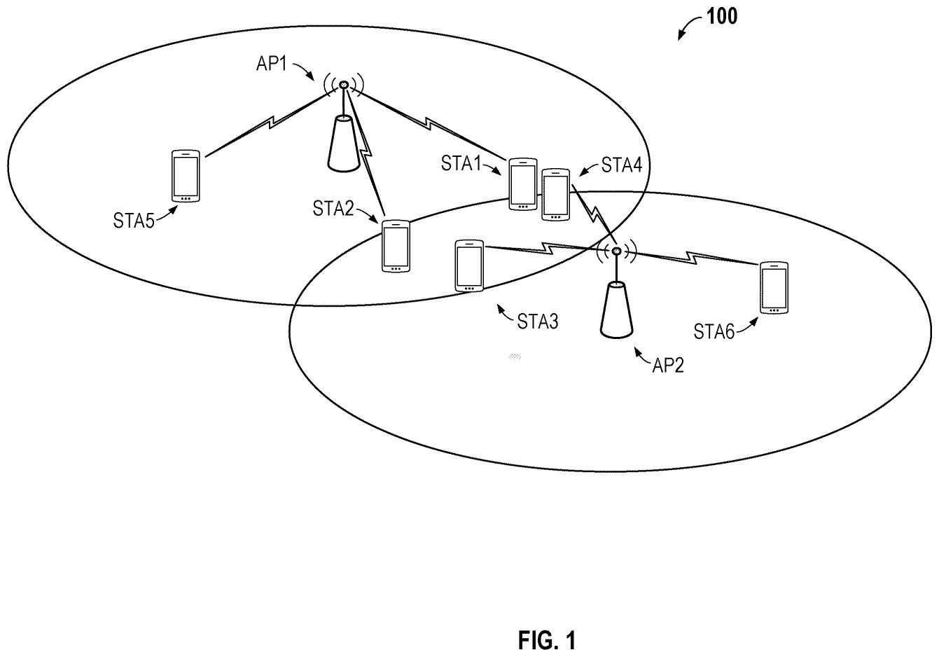

FIG. 1 is a schematic diagram of a system 100 including an OBSS between an AP1 and an AP2, according to an embodiment.

Referring to FIG. 1, six STAs are shown by way of example, where four of the STAs are located in service areas associated with both the AP1 and the AP2. Associations between the six STAs and their respective APs are illustrated as comm-links depicted by lightning bolts. As shown in FIG. 1, the STA1, STA2, and STA5 may be associated with the AP1. In addition, the STA3, STA4, and STA6 are shown as associated with the AP2. The STA1, STA2, STA3, and STA4 are in an overlapping service area.

It should be appreciated that different standards may use differing terms for similar functions. Accordingly, “access point” or “AP” may be used interchangeably with other terms, such as a “base station,” “station functioning as an access point,” etc.

As described herein, a wireless network of an AP and its associated STAs can be referred to as a BSS. Further, the term “OBSS” can refer to wireless networks that partially overlap. From a geographic perspective, the OBSS can be viewed as overlapping service areas.

An AP can be any configuration of hardware and software comprising a backhaul equipment for connecting to a wired network, a baseband processor for signal processing of a baseband signal, a modulating unit to modulate and demodulate between the baseband signal and a wireless signal (e.g., received or to be transmitted), and an antenna array that transmits and receives the transmission signal. The antenna array may include a plurality of antennas collectively capable of shaping the antenna's radiation patterns into directional communication beams using, for example, constructive interference between signals emitted by radiating elements of the arrays.

Various transmission modes may be employed for intra-BSS and OBSS STAs, including Co-BF, multi-user (MU)-multiple input, multiple output (MIMO), and/or single user (SU)-MIMO. Co-BF includes the use of beamforming by two APs to transmit to a single STA. The Co-BF may allow the APs of OBSSs to coordinate their respective transmissions to a given STA. For example, with reference to FIG. 1, the AP1 and the AP2 may coordinate their transmissions to each of the STA1 through STA4. However, the AP1 and the AP2 may not be able to coordinate their transmissions to the STA5 and STA6, which lie outside the OBSSs.

With reference to FIG. 1, the STAs in the OBSS may be sounded with intra-BSS and cross-BSS training signals transmitted by the two APs. The STA receiving intra-BSS and the cross-BSS sounding may accordingly provide an intra-BSS and a cross-BSS CSI report via a CSI feedback to an associated AP. The AP receiving the CSI reports can provide the cross-BSS CSI and/or the intra-BSS CSI reports to the other AP.

The cross-BSS CSI reports can be used by the APs in Co-BF procedures. The Co-BF procedures may be defined in a specification. For example, the IEEE P802.11bn/D0.1 standard may define explicit feedback mechanisms, such as the Ultra High Reliability Trigger Based (UHR TB) sequential/joint null data packet (NDP) sounding, for intra-BSS sounding and cross-BSS sounding to measure and report the CSI. These CSI reports can be used to enable concurrent transmissions from two APs to each AP's associated STAs while minimizing interference to cross-BSS/OBSS STAs.

For example, the Co-BF procedures can enable concurrent transmissions with beamforming and carrier frequency synchronization. For example, beamforming by an AP can ensure constructive interference of the AP's transmissions at an intended STA and destructive interference of the AP's transmissions at an unintended STA. In addition, carrier frequency synchronization can ensure that transmissions from two APs to an STA are constructively interfering at the intended STA.

When employing Co-BF, two APs may simultaneously transmit frames to a given STA. The frames transmitted during Co-BF may be sounding frames, data frames, etc. The beams of the two APs can constructively interfere to ensure a sufficiently high signal strength so the STA can receive and process the data frames. Co-BF can also be employed during sounding to, for example, determine a channel matrix characterizing channels between the two APs and the STA.

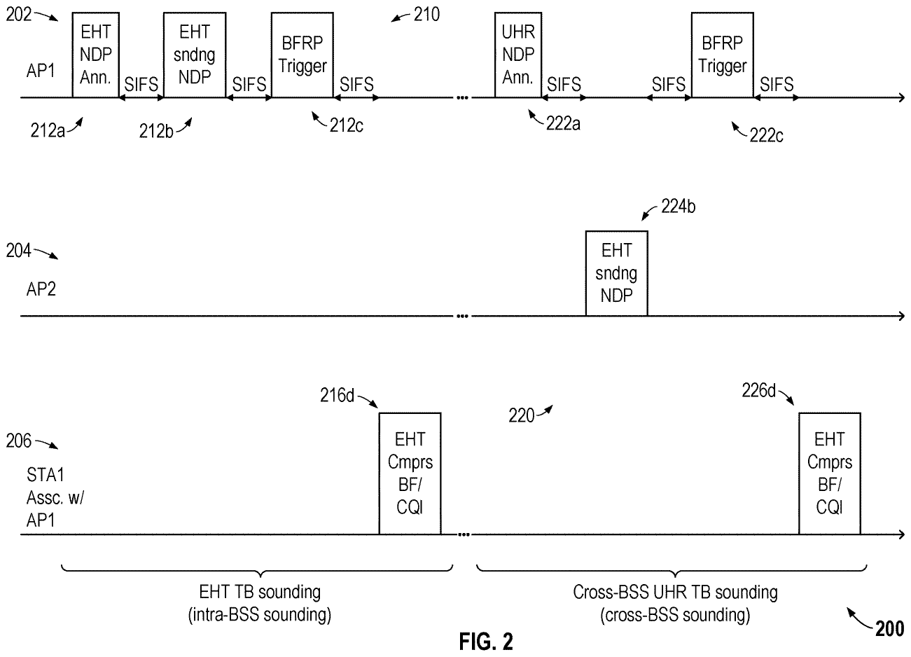

FIG. 2 is a sequence diagram 200 of a sequential sounding sequence with an optional intra-BSS sounding according to an embodiment. Channel sounding includes a process wherein a transmitter, such as the AP1, sends one or more test signals (e.g., training symbols) to a receiver, such as, with reference to FIG. 1, one or more of the AP2 or the STA1, allowing the receiver to determine at least one of a CSI or CQI, and to provide feedback on the characteristics of the channel to the transmitter.

Referring to FIG. 2, the sequence diagram 200 includes an AP1 sequence line 202, an AP2 sequence line 204, and an AP1 associated STAs line 206. The AP1 sequence line 202, AP2 sequence line 204, and AP1 associated STAs line 206 indicate a time domain sequence of transmissions. For example, the AP1 sequence line 202 illustrates transmissions from an AP1, such as the AP1 described with reference to FIG. 1. Similarly, the AP2 sequence line 204 indicates transmission from an AP2, such as the AP2 described with reference to FIG. 1. The AP1 associated STAs line 206 indicates transmissions from STAs that are associated with the AP1, such as, for example, the STA1, STA2, and STA5 described with reference to FIG. 1. It should be appreciated that the sequences described with reference to FIG. 2 are exemplary and other suitable sequences may be employed.

Also shown in FIG. 2 is an extremely high throughput (EHT) TB sounding sequence 210 and a cross-BSS UHR TB sounding sequence 220, although any suitable sequence, sequence groupings, ordering, etc. can be employed. The EHT TB sounding sequence 210 and the cross-BSS UHR TB sounding sequence 220 include transmissions illustrated as blocks adjacent the AP1 sequence line 202, the AP2 sequence line 204, and/or the AP1 associated STAs line 206.

As can be appreciated, the EHT TB sounding sequence 210 is an intra-BSS sounding and the cross-BSS UHR TB sounding sequence 220 is a cross-BSS sounding. More specifically, the EHT TB sounding sequence 210 may be referred to as an AP1 intra-BSS sounding and the cross-BSS UHR TB sounding sequence 220 may be referred to as an AP1 cross-BSS sounding because the AP1 initiates and controls the EHT TB sounding sequence 210 and the cross-BSS UHR TB sounding sequence 220.

Accordingly, referring to FIG. 2, the EHT TB sounding sequence 210 and the cross-BSS UHR TB sounding sequence 220 may include transmissions from the AP1, AP2, and/or the AP1 associated STAs. For example, the EHT TB sounding sequence 210 is shown as comprising an AP1 EHT NDP announcement 212a, an AP1 EHT sounding NDP 212b, an AP1 beamforming report poll (BFRP) trigger 212c, and an AP1 associated STA EHT compressed BF/CQI 216d. The cross-BSS UHR TB sounding sequence 220 is shown in FIG. 2 as being comprised of an AP1 UHR NDP announcement 222a, an AP2 EHT sounding NDP 224b, and an AP1 BFRP trigger 222c, and an AP1 associated STA EHT compressed BF/CQI 226d.

Also shown in FIG. 2 are short inter-frame spaces (SIFS) between each transmission. The SIFS is an amount of time that a wireless interface requires in order to process a received frame and respond with a response frame. For example, the SIFS may be an interframe spacing used before transmitting acknowledgements, clear to send (CTS) frames, block acknowledgment (ACK) frames, or other responses in an IEEE 802.11 wireless network. The length of the SIFS may depend on the physical layer used in the wireless network, and may include delays in receiver radio frequency (RF), Physical Layer Convergence Protocol (PLCP), and MAC processing.

The EHT TB sounding sequence 210 may be a protocol wherein the AP1 controls the transmission of a training signal, such as at least one EHT sounding NDP, to measure channel characteristics, enabling Orthogonal Frequency-Division Multiple Access (OFDMA) and/or MU-MIMO uplink transmissions. As can be appreciated from the foregoing discussion, the EHT TB sounding sequence 210 may begin with the AP1 EHT NDP announcement 212a used to announce an intent to perform an EHT beamforming and channel sounding for multi-user transmissions. The AP1 EHT sounding NDP 212b may be used by a beamformer, such as one or more of the AP1 or the AP2, to probe the channel characteristics for transmit beamforming and downlink MU-MIMO operations.

Still referring to the EHT TB sounding sequence 210, the AP1 BFRP trigger 212c may be sent to solicit beamforming feedback from multiple STAs for channel sounding and multi-user transmission. The AP1 BFRP trigger 212c may specify one or more parameters to be used by the STAs to send beamforming reports to the AP1. An STA associated with the AP1, such as STA1 described with reference to FIG. 1, may generate the AP1 associated STA EHT compressed BF/CQI 216d that includes a beamforming steering matrix and CQI in a compressed format. The AP1 associated STA EHT compressed BF/CQI 216d may provide efficient feedback from one or more beamformees to one or more beamformers for enhanced or optimized MU-MIMO communications.

Turning to the cross-BSS UHR TB sounding sequence 220, the AP1 UHR NDP announcement 222a may similarly announce the intent to perform the cross-BSS UHR TB sounding. The AP2 EHT sounding NDP 224b may perform the sounding of the AP1 associated stations, such as, for example, the STA1 described with reference to FIG. 1. The STA1 associated with the AP1 can generate the AP1 associated STA EHT compressed BF/CQI 226d. The AP1 associated STA EHT compressed BF/CQI 226d may be transmitted by the STA1 to the AP1.

Accordingly, the MAC may use a defined frame exchange sequence for performing sequential sounding. In some examples, while cross-BSS sounding may be required, intra-BSS sounding may be an optional function that can be enabled and/or disabled. For example, intra-BSS sounding may be omitted or adjusted when (1) an initiating AP (e.g., AP1 or AP2 described with reference to FIG. 1) has already recently obtained one or more needed CSIs from single AP single-user (SU) and/or MU-MIMO sounding or Co-BF sounding with other APs, and/or (2) reducing sounding time by omitting or adjusting intra-BSS sounding from a sequential sounding sequence. Adjusting or omitting intra-BSS sounding from a sequential sounding sequence may improve an overall system throughput and, additionally, render the cross-BSS sounding more updated and increase the effectiveness of interference nulling.

Each of the APs that participate in the sequential sounding, such as the AP1 and the AP2 described in the foregoing, may indicate if they would like to adjust (e.g., omit) an intra-BSS sounding step in the sequential sounding sequence. The indication may have different variations. For example, the variations may be implicit. The AP can exchange its own intra-BSS status through frame exchanges and its intention to adjust (e.g., omit) their intra-BSS sounding at the beginning of sounding. The AP can intentionally adjust or omit the intra-BSS sounding for part or all of the STAs associated with the AP. The sharing AP can directly start to trigger Co-BF transmission without an intra-BSS sounding of the other AP if it is informed that the other AP has all its intra-BSS CSI.

The AP may use a single bit to indicate to omit the intra-BSS sounding of all the STA(s) which are scheduled to do Co-BF sounding. Adjusting (e.g., omitting) all of the STA(s) from the sequential sounding sequence can save the time required for the intra-BSS sounding. The AP may also use multiple-bit (e.g., the encoding could vary) to indicate if any specific STA may not participate in an intra-BSS sounding. Using the encoding may provide more flexibility compared to the single bit. It should be appreciated that sounding time may not be saved unless the AP indicates that every associated STA will skip the intra-BSS sounding stage. The following describes an exemplary implementation of the indication.

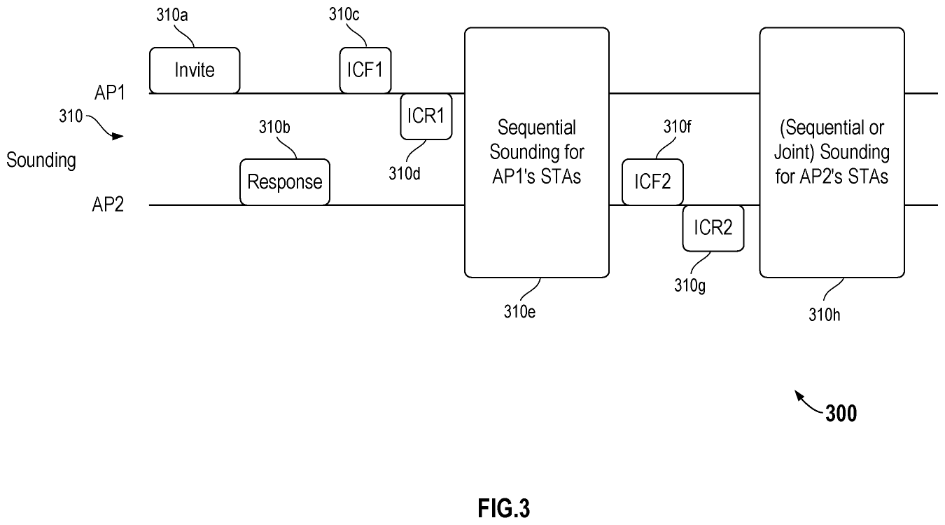

FIG. 3 is a sequence diagram 300 of a sequential sounding with an optional intra-BSS sounding according to an embodiment. As shown in FIG. 3, the sequential sounding may precede other soundings and, although not shown, a Co-BF with data transmissions.

Referring to FIG. 3, the sequence diagram 300 includes an invite sounding sequence 310. The invite sounding sequence 310 may include an invite 310a transmitted by AP1 and a response 310b transmitted by AP2. The invite sounding sequence 310 can also include a first initial control frame (ICF) frame 310c transmitted by AP1 to one or more intra-BSS STAs. The one or more intra-BSS STAs can respond with a first initial control response (ICR) 310d. The invite sounding sequence 310 can also include a sequential sounding for AP1's STAs 310e. If cross-BSS sounding is employed in the sounding for AP1's STAs 310e then a first null data packet announcement (NDPA) may be employed for synchronization with other APs. The invite sounding sequence 310 can also include a second ICF 310f and a second ICR 310g and a sounding for AP2's STAs 310h.

An indication of whether or not intra-BSS sounding may be performed can be provided in any of various places, using any of various techniques. In some examples, an intra-BSS may be disabled and/or enabled prior to the sounding. For example, the ICF 310f and/or ICR 310g can indicate whether or not intra-BSS sounding is to be performed during the sequential sounding of the AP1's STAs 310e. Alternatively, or additionally, the ICF 310f and/or ICR 310g frames may be used to initiate a capability switch request, either from a multi-link AP to an STA, or from the STA to the multi-link AP, for Dynamic Power Save (DPS) or Enhanced Multilink Single-Radio Operation (EMLSR).

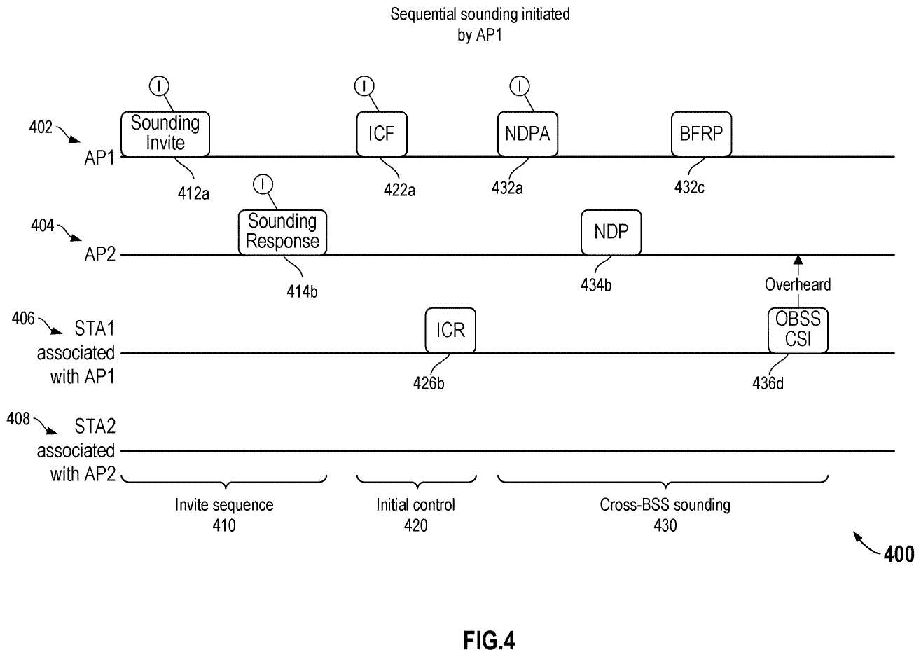

FIG. 4 shows a sequence diagram 400 of a sequential sounding sequence with an optional intra-BSS sounding according to an embodiment. The sequence diagram 400 is an example of sequential sounding of an STA where an intra-BSS sounding is adjusted or omitted. That is, an AP considers a sequential sounding sequence that includes the intra-BSS sounding of the STA but determines that the intra-BSS sounding may be adjusted or omitted and when the sequential sounding is performed by the AP1 and the AP2. It should be appreciated that other exemplary sequential soundings where an optional intra-BSS sounding is adjusted or omitted may be employed.

Referring to FIG. 4, the sequence diagram 400 includes an AP1 sequence line 402, an AP2 sequence line 404, an STA1 sequence line 406, and an STA2 sequence line 408. The sequence diagram 400 is also shown as including an invite sequence 410, an initial control sequence 420, and a cross-BSS sounding 430. The invite sequence 410 includes a sounding invite 412a transmitted by the AP1 and a sounding response 414b transmitted, in response to the sounding invite 412a, by the AP2. The initial control sequence 420 is shown as including an ICF 422a transmitted by the AP1 and an ICR 426b transmitted, in response to the ICF 422a, by the STA1. As shown in FIG. 4, the cross-BSS sounding 430 may include an NDPA 432a transmitted by the AP1, an NDP 434b transmitted by the AP2, a BFRP 432c transmitted by the AP1, and an OBSS CSI 436d transmitted by the STA1.

As can be appreciated from the sequence diagram 400, an intra-BSS sounding is adjusted (e.g., omitted) from the sequential sounding, which may be based on an indication transmitted by the AP1 and/or the AP2. The possible transmissions of an indication are denoted with a circled I caption of the transmissions by the AP1 and the AP2. As shown in FIG. 4, the indication may be transmitted by the AP1 via the sounding invite 412a, the ICF 422a, and/or the NDPA 432a. Additionally, or alternatively, the AP2 may transmit the indication via the sounding response 414b.

To illustrate an advantageous effect of an indication, a single transmit opportunity (TXOP) case may be considered. An AP1/AP2 sounding sequence may be defined as including an AP1 cross-BSS sounding, an AP1 intra-BSS sounding, an AP2 cross-BSS sounding, and an AP2 intra-BSS sounding. The AP1 cross-BSS sounding may be initiated by an NDPA transmitted by the AP1 and heard by the AP2. The AP2 may transmit an NDP that is received by an STA associated with the AP1. The STA associated with the AP1 can transmit an OBSS CSI report to AP1 based on the NDP transmitted by the AP2. Similarly, the AP2 cross-BSS sounding may begin with the AP2 transmitting an NDPA that is received by the AP1. The AP1 may transmit, in response to the received NDPA, an NDP. The NDP may be received by an STA associated with the AP2. The STA associated with the AP2 can transmit an OBSS CSI report to the AP2 based on the NDP received from the AP1.

A complete sequential sounding sequence that includes the sequences described above may begin with an invite/response sequence similar to the invite sequence 410 described with reference to FIG. 4 followed by sounding stages. Each sounding stage k may start from start time tₖ₋₁ and end at end time tₖ with a length of Tₖ. Accordingly, the AP1 cross-BSS sounding may be a stage 1 beginning at start time t₀ and having a first length T₁, the AP1 intra-BSS sounding may be a stage 2 beginning at a start time t₁ having a second length T₂, the AP2 cross-BSS sounding may be a stage 3 beginning at start time t₂ and having a length T₃, and the AP2 intra-BSS sounding may be a stage 4 beginning at time t₃ and having a length T₄.

If the AP1 wants to adjust (e.g., omit) the AP1 intra-BSS sounding and thus remove the second stage having a length T2 from the sequential sounding sequence, the AP2 may be expected to send its NDPA of the stage 3 at time t1 instead of t₂. Without an indication transmitted from AP1 (e.g. in the invite frame), AP2 is unable to make this determination. Similarly, if AP2 wants to skip the AP2 intra-BSS sounding such that the stage 4 having a length T4 is removed, AP1 should reserve only a TXOP of length T1+T2+T3 instead of the length of T1+T2+T3+T4. However, without an indication from AP2 (e.g. in the Response frame), AP1 cannot make such a determination. Accordingly, an indication being transmitted by AP1 and/or AP2 can ensure that the other AP can determine what behavior to expect.

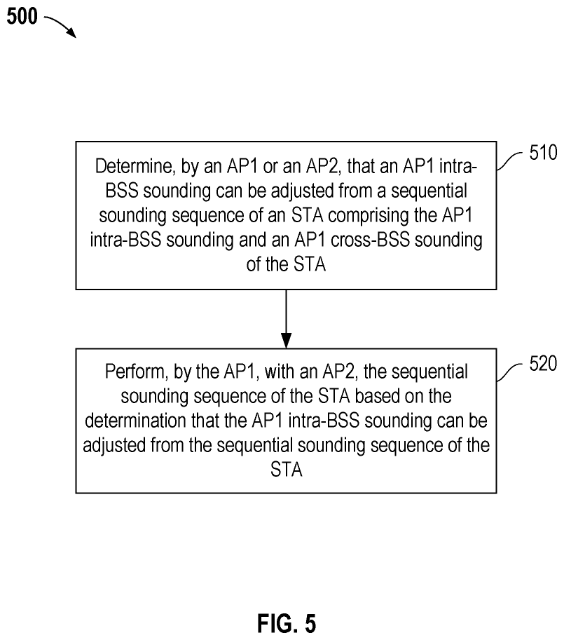

FIG. 5 is a method 500 for sequential sounding sequence including an intra-BSS sounding according to an embodiment.

Referring to FIG. 5, the method 500 can determine, by an AP1 or an AP2, that an AP1 intra-BSS sounding can be adjusted from a sequential sounding sequence of an STA comprising the AP1 intra-BSS sounding and an AP1 cross-BSS sounding of the STA in step 510. For example, the method 500 can determine, by the AP1, that the AP1 has a CSI of the STA, although any suitable determination can be employed. In step 520, the method 500 can perform, by the AP1, with an AP2, the sequential sounding sequence of the STA based on the determination that the AP1 intra-BSS sounding can be adjusted from the sequential sounding sequence of the STA. For example, the method 500 can determine that the AP1 intra-BSS can be omitted from the sequential sounding sequence of the STA.

The method 500 can further comprise transmitting, by the AP1, an indication that the AP1 intra-BSS sounding can be adjusted from the sequential sounding sequence of the STA. For example, the method 500 can transmit, by the AP1, the indication that the AP1 intra-BSS sounding can be adjusted from the sequential sounding sequence of the STA by transmitting, with the AP1, at least one of an AP1 intra-BSS sounding status of the STA and a planned adjustment of the AP1 intra-BSS sounding from the sequential sounding sequence of the STA. The method 500 can further comprise transmitting a request from the AP1 to an STA or from the STA to the AP1 for a DPS or an EMLSR mode, wherein the AP1 is a multilink AP.

Additionally, or alternatively, the method 500 can transmit, by the AP1, at least one of a bit to indicate that the AP1 intra-BSS sounding is to be adjusted from at least a portion of scheduled Co-BF sounding of the STA or at least one bit indicating that the AP1 sounding of the STA of a plurality of bitmapped STAs can be adjusted from the sequential sounding sequence of the STA. The method 500 can also transmit, by the AP1, an ICF including the indication that the AP1 intra-BSS sounding can be adjusted from the sequential sounding sequence of the STA.

The method 500 may also transmit, by the AP2, an indication that the AP1 intra-BSS sounding can be omitted from the sequential sounding sequence of the STA. For example, the AP2 can transmit at least one of a bit to indicate that the AP1 intra-BSS sounding is to be adjusted from all scheduled Co-BF sounding of the STA or at least one bit indicating that the AP1 intra-BSS sounding of the STA of a plurality of bitmapped STAs can be adjusted from the sequential sounding of the STA. Additionally, or alternatively, the AP2 can transmit a sounding response including the indication that the AP1 intra-BSS sounding can be adjusted from the sequential sounding sequence of the STA.

The method 500 can further comprise disabling, by the AP1, the AP1 intra-BSS sounding based on the determination, by the AP1, that the AP1 intra-BSS sounding can be adjusted from the sequential sounding sequence of the STA. The method 500 may also further comprise determining, with the AP2, that an AP2 intra-BSS sounding may be adjusted from an additional sequential sounding sequence of the STA and initiating, by the AP1, a Co-BF transmission based on the determinations that the AP1 intra-BSS sounding can be adjusted from the sequential sounding sequence of the STA and the AP2 intra-BSS sounding can be adjusted from the additional sequential sounding sequence of the STA.

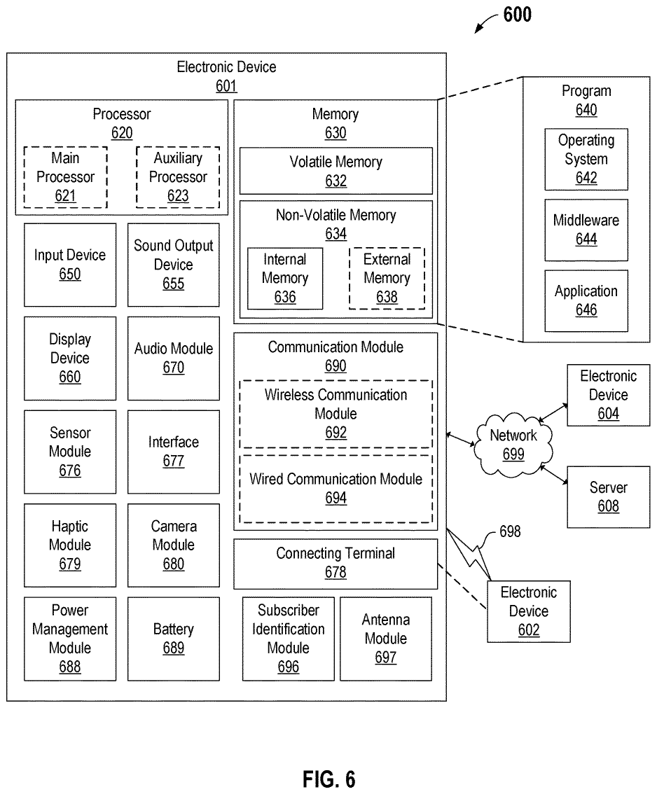

FIG. 6 is a block diagram of an electronic device in a network environment 600, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (APr), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the SIM card 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

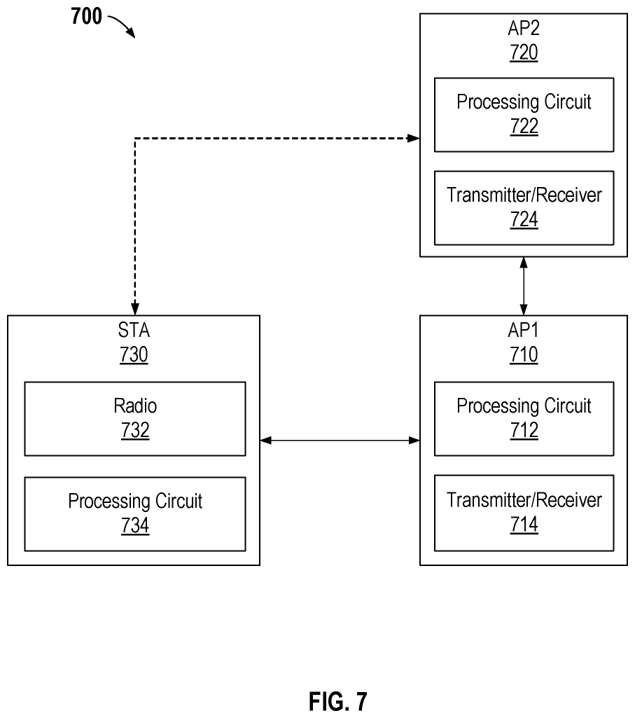

FIG. 7 shows a system 700 including an AP1 710, an AP2 720, and an STA 730.

Referring to FIG. 7, the AP1 710 is communicatively coupled with the STA 730 illustrated by a solid line. The AP1 710 may be communicatively coupled with the STA 730 via wireless uplinks and/or downlinks. The AP1 710 and the AP2 720 are also communicatively coupled with each other as is also illustrated by a solid line. The AP1 710 and the AP2 720 may be communicatively coupled with each other through backhaul connections, fronthaul wireless communications, and/or etc. The AP2 720 and the STA 730 are not shown as being communicatively coupled but instead include some transmissions, direct or indirect between the AP2 720 and the STA 730 as is illustrated by the dashed arrow line.

With reference to FIGS. 1 and 7, the AP1 710 and the STA 730 may be considered associated with each other and thus be part of a BSS. For example, the STA 730 and the AP1 710 may respectively be the STA2 and AP1 shown in FIG. 1. Accordingly, the BSS that includes the AP1 710 and the STA 730 shown in FIG. 7 may overlap with another BSS that includes the AP2 720 and thus may be an OBSS. The AP2 720 may therefore, for example, overhear communications between the AP1 710 and the STA 730 even though the AP2 720 may not be communicatively coupled with (e.g., associated with) the STA 730.

The AP1 710 and the AP2 720 may be any suitable combination of hardware and/or software that can provide wireless services to the STA 730. For example, the AP1 710 and the AP2 720 may respectively be comprised of a processing circuit 712, 722 and a transmitter/receiver 714, 724. The processing circuits 712, 722 may be any suitable combination of circuits, registers, code, and/or the like that can perform computations, such as, for example, those described herein. Additionally, or alternatively, the AP1 710 and the AP2 720 may be comprised of antennas (e.g., in one or more antenna arrays) for communications with, for example, the STA 730 and/or each other, a wired network interface to a router or switch, and/or the like. It should be appreciated that the term “access point” may be interchangeable with other terms such as “base station”, Next-Generation Node B (gNB), etc.

The STA 730 may include a radio 732 and a processing circuit 734. The radio 732 may perform various methods disclosed herein. For example, the processing circuit 734 may receive, via the radio 732, transmissions from the AP1 710, and the processing circuit 734 may transmit, via the radio 732, signals to the AP1 710. Accordingly, the AP1 710 can transmit, for example, packets with or without data (e.g., symbols) via a transmission (e.g., across specific spatial stream) from the AP1 710 to the STA 730.

It should also be appreciated that the AP2 720 can also transmit to the STA 730 even though the AP2 720 and the STA 730 may not be associated. For example, the AP1 710 and/or the AP2 720 may transmit an NDPA to coordinate sequential and/or simultaneous transmissions from AP1 710 and/or AP2 720 to the STA 730 as is described in the foregoing. By way of illustration, based on the NDPA, the AP1 710 and/or the AP2 720 can transmit an NDP, simultaneously, sequentially, or individually, to the STA 730.

Accordingly, the AP1 710 or the AP2 720 can include a processing circuit 712, 722 configured to determine that an AP1 intra-BSS sounding can be adjusted (e.g., omitted) from a sequential sounding sequence of an STA comprising the AP intra-BSS sounding and an AP cross-BSS sounding sequence of the STA 730 and a transmitter/receiver 714, 724 configured to transmit an indication that the AP intra-BSS sounding can be adjusted from the sequential sounding of the STA 730. The transmitter/receiver 714, 724 may also be configured to transmit the indication that the AP intra-BSS sounding can be adjusted from the sequential sounding of the STA 730 by transmitting at least one bit to adjust the STA 730 from the AP intra-BSS sounding.

For example, one of the AP1 710 or the AP2 720 may be configured to determine that an AP1 intra-BSS sounding can be adjusted from a sequential sounding sequence of an STA 730 comprising the AP1 intra-BSS sounding and an AP1 cross-BSS sounding of the STA 730. In addition, the AP1 710 and the AP2 720 may be configured to perform the sequential sounding sequence of the STA 730 based on the determination that the AP1 intra-BSS sounding can be adjusted from the sequential sounding sequence of the STA 730.

It should be appreciated that the AP1 710 or the AP2 720 being configured to determine that the AP1 intra-BSS sounding can be adjusted from the sequential sounding sequence of the STA 730 can comprise one of the AP1 710 or the AP2 720 being configured to determine that the AP1 710 has a CSI of the STA 730.

The AP1 710 or the AP2 720 may be further configured to transmit an indication that the AP1 intra-BSS sounding can be adjusted from the sequential sounding sequence of the STA 730. For example, the AP1 710 being configured to transmit at least one of an AP1 intra-BSS sounding status of the STA and a planned adjustment of the AP1 intra-BSS sounding from the sequential sounding sequence of the STA. Additionally, or alternatively, the AP1 710 or the AP2 720 may be configured to transmit at least one of a bit to indicate that the AP1 intra-BSS sounding is to be adjusted from at least one scheduled Co-BF sounding of the STA 730 or at least one bit indicating that the AP1 sounding of the STA 730 of a plurality of bitmapped STAs can be adjusted from the sequential sounding of the STA 730. Also additionally, or alternatively, the AP1 710 may be configured to transmit an ICF and/or the AP2 720 may be configured to transmit a sounding response including the indication the AP1 intra-BSS sounding can be adjusted from the sequential sounding sequence of the STA 730.

The AP1 710 may be further configured to disable the AP1 intra-BSS sounding based on the determination that the AP1 intra-BSS sounding can be adjusted from the sequential sounding of the STA 730. The AP2 720 may be further configured to determine that an AP2 intra-BSS sounding can be adjusted from an additional sequential sounding sequence of the STA 730. The AP1 710 may be further configured to initiate a Co-BF transmission based on the determinations that the AP1 intra-BSS sounding can be adjusted from the sequential sounding sequence of the STA 730 and the AP2 intra-BSS sounding can be adjusted from the additional sequential sounding sequence of the STA 730.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus.

Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
determining, by a first access point (AP1), that an AP1 intra-basic service set (BSS) sounding can be adjusted from a sequential sounding sequence of a station (STA) comprising the AP1 intra-BSS sounding and an AP1 cross-BSS sounding of the STA; and
performing, by the AP1, with a second access point (AP2), the sequential sounding sequence of the STA based on the determination that the AP1 intra-BSS sounding can be adjusted from the sequential sounding sequence of the STA.

2. The method of claim 1, wherein determining, by the AP1, that the AP1 intra-BSS sounding can be adjusted from the sequential sounding sequence of the STA comprises determining, by the AP1, that the AP1 has a channel state information (CSI) of the STA.

3. The method of claim 1, further comprising transmitting, by the AP1, an indication that the AP1 intra-BSS sounding can be adjusted from the sequential sounding sequence of the STA.

4. The method of claim 3, wherein transmitting, by the AP1, the indication that the AP1 intra-BSS sounding can be adjusted from the sequential sounding sequence of the STA comprises transmitting, with the AP1, at least one of an AP1 intra-BSS sounding status of the STA and a planned adjustment of the AP1 intra-BSS sounding from the sequential sounding sequence of the STA.

5. The method of claim 3, wherein transmitting, by the AP1, the indication that the AP1 intra-BSS sounding can be adjusted from the sequential sounding sequence of the STA comprises transmitting, by the AP1, at least one of a bit to indicate that the AP1 intra-BSS sounding is to be adjusted from at least a portion of scheduled coordinated beamforming (Co-BF) sounding of the STA or at least one bit indicating that the AP1 sounding of the STA of a plurality of bitmapped STAs can be adjusted from the sequential sounding sequence of the STA.

6. The method of claim 3, wherein transmitting, by the AP1, the indication that the AP1 intra-BSS sounding can be adjusted from the sequential sounding sequence of the STA comprises transmitting, by the AP1, an initial control frame (ICF) including the indication that the AP1 intra-BSS sounding can be adjusted from the sequential sounding sequence of the STA.

7. The method of claim 1, further comprising disabling, by the AP1, the AP1 intra-BSS sounding based on the determination, by the AP1, that the AP1 intra-BSS sounding can be adjusted from the sequential sounding sequence of the STA.

8. The method of claim 1, further comprising:
determining, with the AP2, that an AP2 intra-BSS sounding may be adjusted from an additional sequential sounding sequence of the STA; and
initiating, by the AP1, a coordinated beamforming (Co-BF) transmission based on the determinations that the AP1 intra-BSS sounding can be adjusted from the sequential sounding sequence of the STA and the AP2 intra-BSS sounding can be adjusted from the additional sequential sounding sequence of the STA.

9. The method of claim 1, wherein determining that the AP1 intra-BSS sounding can be adjusted from the sequential sounding sequence of the STA comprises determining that the AP1 intra-BSS sounding can be omitted from the sequential sounding sequence of the STA.

10. The method of claim 1, further comprising transmitting a request from the AP1 to an STA or from the STA to the AP1 for a dynamic power save (DPS) or an Enhanced Multilink Single-Radio Operation (EMLSR) mode, wherein the AP1 is a multilink AP.

11. A method comprising:
determining, by a second access point (AP2), that a first access point (AP1) intra-basic service set (BSS) sounding can be adjusted from a sequential sounding sequence of a station (STA) comprising the AP1 intra-BSS sounding and an AP1 cross-BSS sounding of the STA; and
performing, with the AP1, by the AP2, the sequential sounding sequence of the STA based on the determination that the AP1 intra-BSS sounding can be adjusted from the sequential sounding sequence of the STA.

12. The method of claim 11, further comprising transmitting, by the AP2, an indication that the AP1 intra-BSS sounding can be omitted from the sequential sounding sequence of the STA.

13. The method of claim 12, wherein transmitting, by the AP2, the indication that the AP1 intra-BSS sounding can be adjusted from the sequential sounding sequence of the STA comprises transmitting, by the AP2, at least one of a bit to indicate that the AP1 intra-BSS sounding is to be adjusted from all scheduled coordinated beamforming (Co-BF) sounding of the STA or at least one bit indicating that the AP1 intra-BSS sounding of the STA of a plurality of bitmapped STAs can be adjusted from the sequential sounding of the STA.

14. The method of claim 12, wherein transmitting, by the AP2, the indication that the AP1 intra-BSS sounding can be adjusted from the sequential sounding sequence of the STA comprises transmitting, by the AP2, a sounding response including the indication that the AP1 intra-BSS sounding can be adjusted from the sequential sounding sequence of the STA.

15. A system comprising:
a first access point (AP1); and
a second access point (AP2), wherein:
one of the AP1 or the AP2 is configured to determine that an AP1 intra-basic service set (BSS) sounding can be adjusted from a sequential sounding sequence of a station (STA) comprising the AP1 intra-BSS sounding and an AP1 cross-BSS sounding of the STA; and
the AP1 and the AP2 are configured to perform the sequential sounding sequence of the STA based on the determination that the AP1 intra-BSS sounding can be adjusted from the sequential sounding sequence of the STA.

16. The system of claim 15, wherein the one of the AP1 or the AP2 being configured to determine that the AP1 intra-BSS sounding can be adjusted from the sequential sounding sequence of the STA comprises the one of the AP1 or the AP2 being configured to determine that the AP1 has a channel state information (CSI) of the STA.

17. The system of claim 15, wherein the one of the AP1 or the AP2 is further configured to transmit an indication that the AP1 intra-BSS sounding can be adjusted from the sequential sounding sequence of the STA.

18. The system of claim 17, wherein the one of the AP1 or the AP2 being configured to transmit the indication that the AP1 intra-BSS sounding can be adjusted from the sequential sounding sequence of the STA comprises the AP1 being configured to transmit at least one of an AP1 intra-BSS sounding status of the STA and a planned adjustment the AP1 intra-BSS sounding from the sequential sounding sequence of the STA.

19. The system of claim 17, wherein the one of the AP1 or the AP2 being configured to transmit the indication that the AP1 intra-BSS sounding can be adjusted from the sequential sounding sequence of the STA comprises the one of the AP1 or the AP2 being configured to transmit at least one of a bit to indicate that the AP1 intra-BSS sounding is to be adjusted from at least one scheduled coordinated beamforming (Co-BF) sounding of the STA or at least one bit indicating that the AP1 sounding of the STA of a plurality of bitmapped STAs can be adjusted from the sequential sounding of the STA.

20. The system of claim 17, wherein the one of the AP1 or the AP2 being configured to transmit the indication that the AP1 intra-BSS sounding can be adjusted from the sequential sounding sequence of the STA comprises one of the AP1 being configured to transmit an initial control frame (ICF) or the AP2 being configured to transmit a sounding response including the indication the AP1 intra-BSS sounding can be adjusted from the sequential sounding sequence of the STA.

21. The system of claim 15, wherein the AP1 is further configured to disable the AP1 intra-BSS sounding based on the determination that the AP1 intra-BSS sounding can be adjusted from the sequential sounding of the STA.

22. The system of claim 15, wherein:
the AP2 is further configured to determine that an AP2 intra-BSS sounding may be adjusted from an additional sequential sounding sequence of the STA; and
the AP1 is further configured to initiate a coordinated beamforming (Co-BF) transmission based on the determinations that the AP1 intra-BSS sounding can be adjusted from the sequential sounding sequence of the STA and the AP2 intra-BSS sounding can be adjusted from the additional sequential sounding sequence of the STA.

23. An access point (AP) comprising:
a processing circuit configured to determine that an AP intra-basic service set (BSS) sounding can be adjusted from a sequential sounding sequence of a station (STA) comprising the AP intra-BSS sounding and an AP cross-BSS sounding sequence of the STA; and
a transmitter/receiver configured to transmit an indication that the AP intra-BSS sounding can be adjusted from the sequential sounding of the STA.

24. The AP of claim 23, wherein the transmitter/receiver being configured to transmit the indication that the AP intra-BSS sounding can be adjusted from the sequential sounding of the STA comprises transmitting at least one bit to adjust the STA from the AP intra-BSS sounding.
